(19) United States
(12) Patent Application Publication
(10) Pub. No.: US 2019/0228680 A1
(43) Pub. Date: Jul. 25, 2019

(54) Nopadol Video Phone Transmitter

(71) Applicant: Nopadol Yamsiriwong, Bronx, NY (US)

(72) Inventor: Nopadol Yamsiriwong, Bronx, NY (US)

(21) Appl. No.: 15/729,671

(22) Filed: Jan. 19, 2018

(51) Int. Cl. G09B 21/00; H05B 33/08; G08B 5/38

(52) U.S. Cl. CPC G09B 21/009; G08B 5/38; H05B 33/0845

(57) ABSTRACT

This series of household reminder kits is a set of public visual reminders electronic devices and methods of the everyday life of deaf people in the United State. It includes a set of wireless transmitter A022 with a videophone connection, a set of doorbell button A011 installed outside the door and a set of flasher receiver A0211 that is easy to see in the room, When the videophone have calling in the flasher receiver will flash white lights to remind the deaf have a videophone calls, when a visitor rang the doorbell button, the flasher receiver can flash red lights to remind deaf people have a guest visit, the two kinds of the most commonly used events reminder at home can be distinguished in flash different colors lights by the same flasher receiver, to timely remind the deaf. The flasher receivers can also be used for temporary lighting.

### TECHTICAL FIELD OF THE INVENTION

Turn the videophone calling in signals and the doorbell ringing signals into RF wireless signals, and transmitted to the receiver, the receiver according to the predetermined light color flash, can be distinguished by visual reminder for the deaf, solve the deaf hearing impairment to the inconvenience of daily life, It is a kind of daily life electronic aid for deaf people.

### BACKGROUND OF THE INVENTION

Now there is no a set of effective and practical products and methods for deaf videophone calling in remind, because the hearing impairment of the deaf they can't hear the videophone ring, although a part of videophone has flashing remind itself, but the brightness and visual range cannot meet the needs of the ordinary life that occupy the home of the deaf, such as videophone in the living room, but the deaf in the kitchen or other room will not be able to know the videophone calling in, the present invention provides an effective solution, and can solve the doorbell remind at the same time, and two events can use different of LED flash distinguish remind.

### SUMMARY OF THE INVENTION

A011 A022/A0211 product series is a set of wireless visual notification system in house. It is simple and practical for deaf and hard of hearing people. It can help the deaf and hard of hearing people to get the two of the most need of event notification in a timely manner at home, can include a videophone calling and the doorbell ringing or other notification, and can accurately distinguish between two kinds of events. It is the same as the hearing people heard the telephone ringing or the doorbell ringing and can handle in time that the deaf and hard of hearing people can easily Answering the videophone or open the door to meet the guests in a timely manner, they will not miss something important.

This product series includes the A011 button (doorbell) transmitter the A022 VP transmitter and the A0211 flasher receiver, it is using radio frequency (RF) technology to realize the event notification signal wireless transmit, A011 and A022 are two different RF signal transmitters, A0211 is an RF signal receiver.

The A011 or A022 transmit the distinctive characteristics radio frequency signal to the A0211 receivers. When the A011 or A022 is transmitting, the A0211 received and start immediately own LED flashing, the A0211 LED flash has two colors light, white and red, can represent A011 transmitters and A022 transmitter respectively, and make a clear distinction between different signal source, users can clearly identify the different event notifications.

For example, it can be set that when A0211 received the A011 transmitted signal start its own red LED flashing and when A0211 received the A022 transmitted signal start its own white LED flashing (of course, can also exchange the A0211 two color LED flash for A011 and A022 each other). The A011 button transmitter used as the doorbell transmitter, when press its red button, the A0211 flasher receiver will start the red LED flashing to notice users have guests visit. The A022 VP (videophone) transmitter and the VP (videophone) main unit properly connected each other later, when the videophone has a telephone calling in, the A022 will automatically transmit signal, the A0211 flasher receiver will start its white LED flashing to notice users have a telephone calling in and remind to answer in a timely manner. So, users can easily distinguish the different event notification from a distance in the house.

### BRIEF DESCRIPTION OF THE DRAWINGS

For more complicate understanding of the feature and advantages of the present invention, provider the corresponding drawings, different drawing number corresponding to different drawing theme, including:

FIG. 1 is schematic diagram depicting one embodiment of a system for providing a VP transmitter, a BT transmitter and a flasher receiver, is to provide videophone calling in and doorbell ringing signal for deaf.

FIG. 2A is the function keys and the appearance of the VP transmitter A022.

FIG. 2B is the working principle block diagram and flow chart of the VP transmitter A022.

FIG. 3A is the appearance and function keys of the BT transmitter A011.

FIG. 3B is the working principle block diagram and flow chart of the BT transmitter A011.

FIG. 4A is the appearance and function keys of the flasher receiver A0211.

FIG. 4B is the working principle block diagram and flow chart of the BT transmitter A0211.

FIG. 5A is the working principle block diagram and system flow diagram of the present invention to realize the flash (white) light reminder function while videophone calling in.

FIG. 5B is the working principle block diagram and system flow diagram of the present invention to realize the flash (red) light reminder function while doorbell ringing.

### DETAILE DESCRIPTION OF THE INVENTION

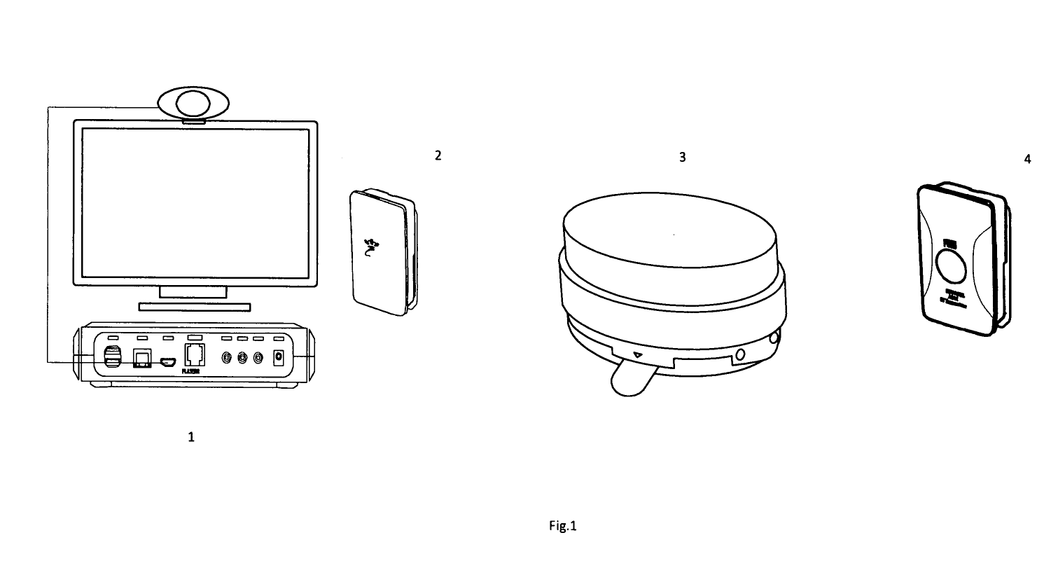

1 in FIG. 1 is the host for the videophone, 2 is a videophone telephone calling signal transmitter (VP transmitter A022), 3 is flash receiver A0211, 4 is the doorbell button transmitter (BT transmitter A011)

When 1 has videophone calling in, 2 transmits RF signals after detected a effective calling in, 3 flash white light after it received the RF signals to remind deaf people having a videophone calling in, when press the button of 4, 4 transmits RF signals, 3 flash red light after it received the RF signals to remind deaf people having guests visiting.

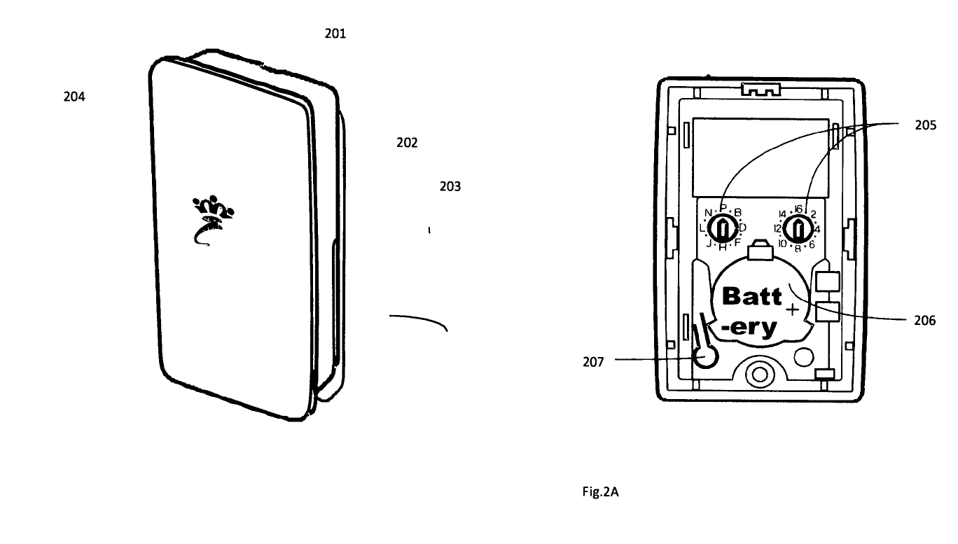

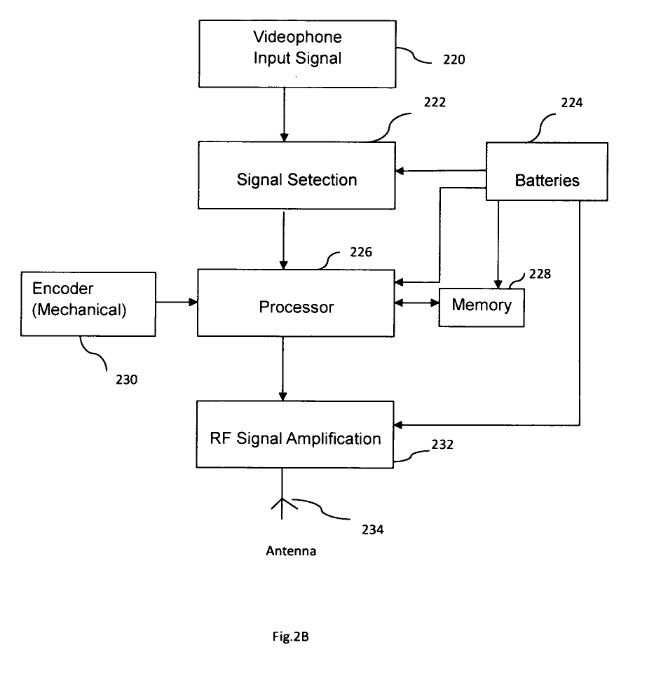

In FIG. 2A, 201 is the VP transmitter body, 202 is the transmitter installation fixed frame, 203 is the plug of the videophone host, 204 is the working indicator light, 205 is mechanical encoder, 206 is a CR2032battery compartments, 207 is to test key.

In FIG. 2B, its working principle is: when 220 input videophone signals, 222 is to test the signals, after detected effective calling in signals, 226 processor is working, namely is reading data out from 228 and triggering RF signals according to the set coding by 230, the RF signals are transmitted out by 234 after they are amplified by 232, among them, 224 is the batteries for the transmitter system working.

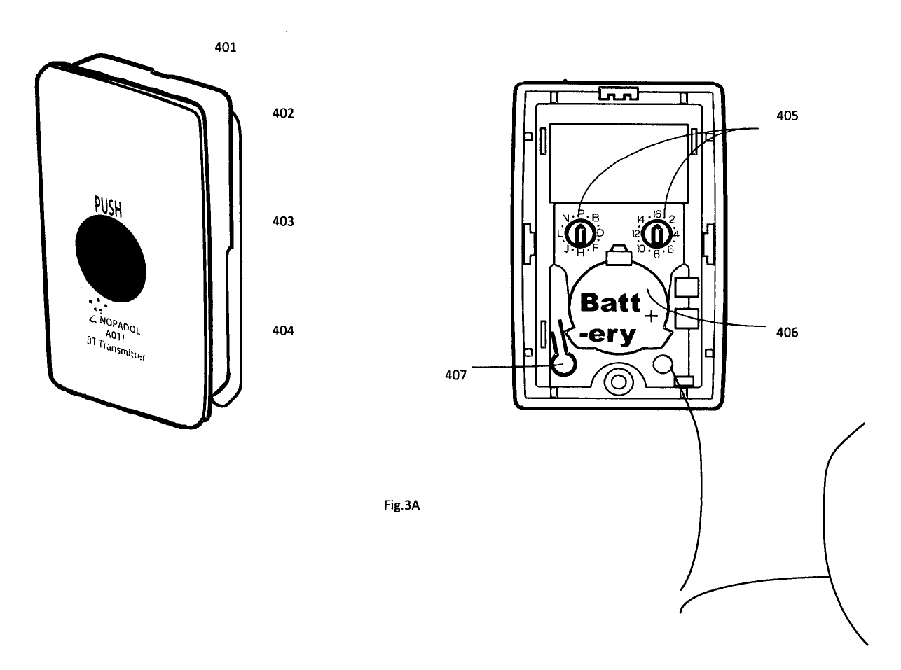

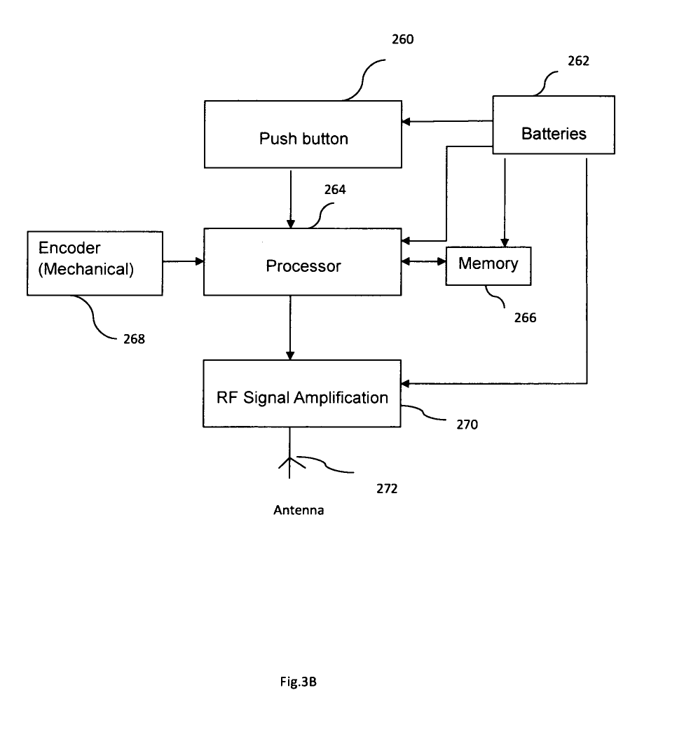

In the FIG. 3A, 401 is the transmitter body, 402 is the work indicator light, 403 is the button, 404 is the Transmitter installation fixed frame, 405 is the mechanical encoder, 406 is CR2032 battery compartment, 407 is the test key.

In FIG. 3B, press the BT transmitter 260 button, 264 just read the corresponding data out from the memory 266 after it has detected the trigger signal, and in accordance with the set code by mechanical 268 encoder sends the RF signal, after be amplified by 270, the RF signal are transmitted out by the antenna 272. The battery 262 provides power for the entire transmitter.

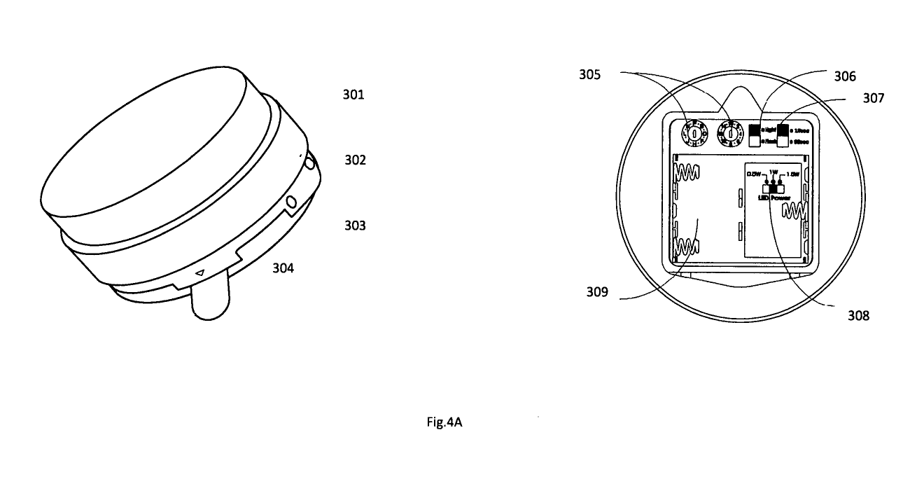

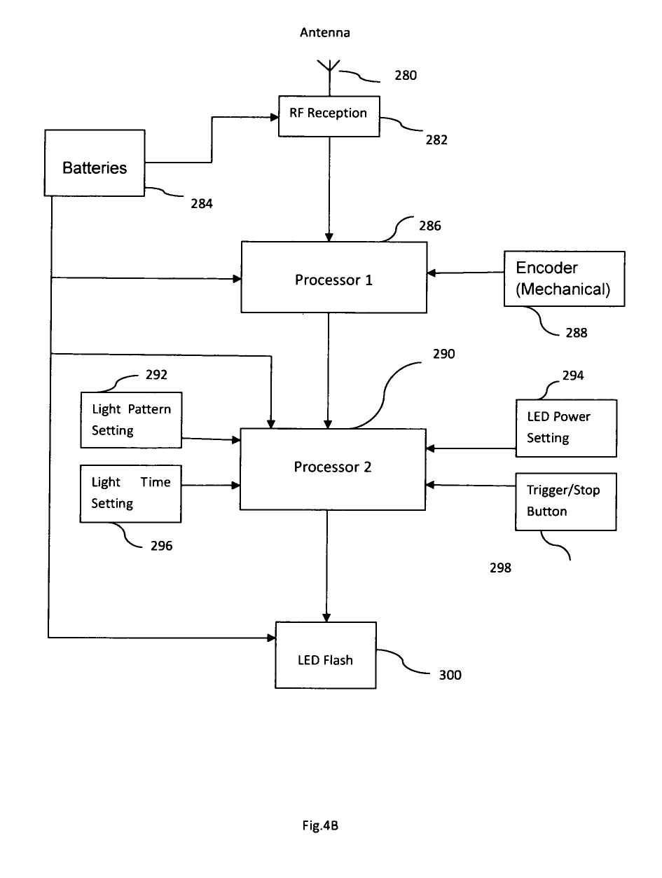

In the FIG. 4A, 301 is the main part of the flasher receiver, 302 is a flashing STOP key and temporary lighting ON/OFF key, 303 is DC 5 V power adapter socket, 304 is installed chassis, 305 is mechanical encoder, 306 is a LED working mode selection Toggle switch with light or flash two kinds of patterns to choose from, 307 is the LED working time set Toggle switch, it has 15 seconds or 90 seconds two optional to choose, 308 is the LED working brightness setting Toggle switch, a total of three kinds

In the FIG. 4B, The RF signals in the air passing through 280 is received by 282, then be processed by 286, 286 has decoded in accordance with Pairing code preset by 288, and then Communication happen between 288 and 290, 290 drive LED 300 to flash according to the LED lighting (flash) part ten set by 292, LED lighting time set by 296 and LED light brightness set by 294, timely remind the deaf.

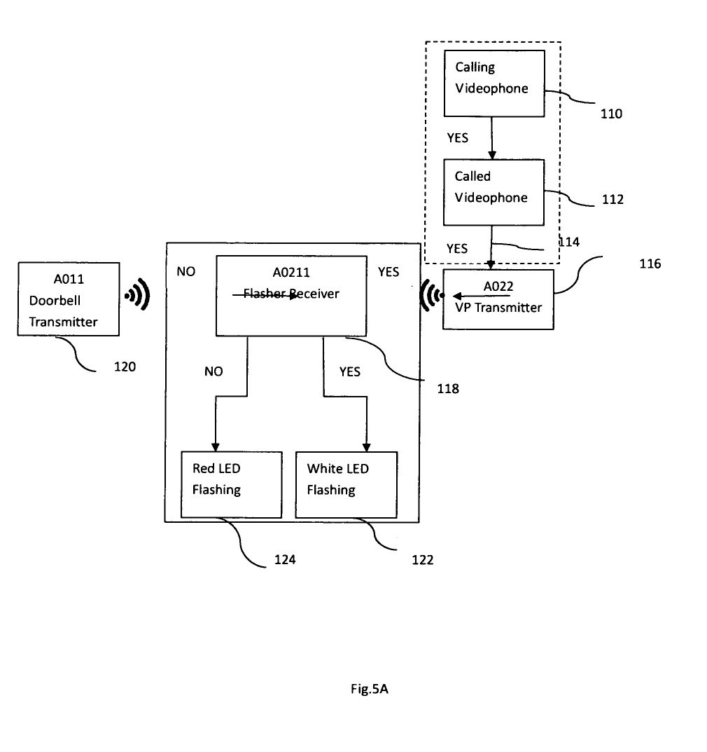

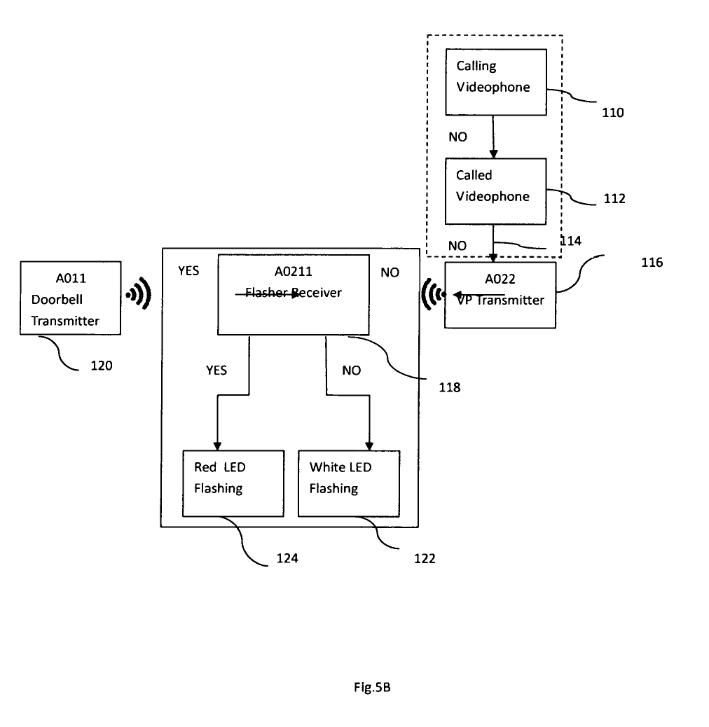

In the FIG. 5A, before we can realize the function of the present invention design, the VP transmitter 116 and BT transmitter 120 were required matching respectively with flash receiver 118 by mechanical coder, and setting up respectively triggering 118 LED flash color (LED lights have two colors, be set by key 207 in FIG. 2A, and key 407 in FIG. 3A, default set VP transmitter triggering 118 LED flash white lights, BT transmitter triggering 118 LED flash red lights). As shown in the figure, when the doorbell transmitter 120 has no signals are transmitted to 118 and videophone 112 has a videophone calling in, in other words, at the same time, videophone 110 is calling 112, 112's calling signal is passing to 116 through 114, and 116 converts videophone calling signals into RF wireless signals and transmit them, after received the wireless signal 118 drive own white LED 124 to flash white lights, to remind deaf people having a videophone calling in.

In FIG. 5B, as previously mentioned, after complete matching and setting, such as graphic, when press the button of the doorbell transmitter (BT transmitter A011), 120 transmit signals, after received RF signals 118 trigger and drive 124 flashing red lights, to remind the deaf having guests visit to ring the doorbell.

What is claim:

1. Please make various claims according to your own needs and the laws of the United Sta
